(19) United States
(12) Patent Application Publication
(10) Pub. No.: US 2004/0022464 A1
(43) Pub. Date: Feb. 5, 2004

(54) Self-aligning bearing assembly with intermediate compliant spherical load ring

(76) Inventors: Alan Schinazi, Providence, RI (US); Robert Schinazi, Providence, RI (US)

Correspondence Address: Charles A. Taylor, Attorney at Law, 9 Valencia Lane, Clifton Park, NY, 12065, US

(21) Appl. No.: 10/211,368

(22) Filed: Aug. 5, 2002

(51) Int. Cl. F16C 23/04

(52) U.S. Cl. 384/192

(57) ABSTRACT

The present invention is a spherical compliant load ring that serves as the interface between the bearing and the bearing housing of a self-aligning bearing assembly and allows the use of a standard cylindrical cartridge bearing. The spherical compliant load ring is an annular structure with a spherically convex surface that is used to mate with the spherically concave surface of the bearing housing. In its preferred embodiment, the ring is made of a material such as plastic, including, but not limited to urethane, Teflon®, Delrin®, Acetal, Polyphenylene Oxide (PPO), Ultem® (polyetherimide), Acrylonitrile-Butadiene-Styrene (ABS), or Nylon® (thermoplastic polyamides), that gives the ring its compliance, strength, and lubricity:

This invention combines the benefits of both metal housings and plastic housings while simplifying the overall complexity of manufacture of the components. With this invention, the bearing assembly retains a metal housing without the need for grinding due to the compliance of the ring material. In addition, the compliant load ring captures the advantages of the plastic housing in that the concave spherical surface requires less precision and thus lower cost manufacturing. In addition, the invention surpasses previous designs in that it eliminates the need for the expensive spherical cartridge bearing and allows the use of the less expensive standard cylindrical cartridge bearing. The compliant ring minimizes the total volume of the plastic (i.e. compliant element) which will maximize the overall stiffness of the system This invention does not limit the choice of bearing housing material.

### BACKGROUND OF THE INVENTION

1. Technical Field of Invention

The present invention relates generally to an improvement in bearing assemblies through the use of an intermediate compliant spherical load ring allowing the bearing assembly to adapt to misalignments. The preferred embodiment is a spherical compliant load ring that serves as the interface between the bearing and the bearing housing and allows the use of a standard cylindrical cartridge bearing. The spherical compliant load ring is an annular structure with a spherically convex surface that is used to mate with the spherically concave surface of the bearing housing.

2. Description of the Related Art

Bearings such as plain bearings, ball bearings, roller bearings, and needle bearings are used to facilitate motion by minimizing friction and thus power consumption and wear. There are two types of bearings, plain and roller. Plain bearings use material properties to reduce friction while roller bearing use specially design components to achieve the same ends. Roller bearings are composed of an outer race, an inner race, and low friction components captured between the races. Needle bearings, a form of roller bearings, may not have an inner race, but use the rotating shaft or object to function as a race. The low friction components are the load bearing elements of the system that enable a sliding motion such that the races are free to move independently of each other. Examples of low friction components are hard metal balls in the case of ball bearings and metal rollers in the case of roller and needle bearings. In use, each race is rigidly affixed to a surface of a system component. Rigidly affixed is defined as no relative motion between the race and the system component. With the races rigidly affixed, the relative motion occurs between the races by way of and supported by the low friction components. However, when a bearing is misaligned during mounting, binding occurs. Binding increases both friction and wear and thus reduces the advantages of the bearing. One way to prevent binding is to use precisely made mounting features. Such features can be milled, ground, or otherwise produced typically at considerable cost and difficulty. Another way to prevent binding is to use a spherical joint as is typical of a bearing housing mounting.

The term pillow block is well know to those versed in the art to describe a bearing assembly comprising a bearing housing, a spherical joint, and a bearing. The bearing housing is the component that affixes the bearing assembly to a reference object and holds the bearing to a relative position with respect to the mounting features. The surfaces of the bearing house and the bearing form the spherical joint. The surface of the bearing housing is a spherically concave annulus. The surface of the bearing is a spherically convex annulus. The bearing in this case is a spherical cartridge bearing. This joint provides two degrees of freedom to compensate for misalignment.

There are two basic materials used in conventional bearing housings, metal and plastic. In conventional metal bearing housings, the spherically concave surface is produced through a tight tolerance grinding process at considerable expense. In conventional plastic housings, the spherically concave surface is produced through the molding process. The quality of the molded surface is less than that of its metal counterpart, but is sufficient due to the compliance of the plastic. Plastic housings are advantageous for use in corrosive environments or where wash downs are required such as in the food processing industry. However, metal housings have the advantage that they are stiffer and stronger. Plastic also has the undesirable effect of cracking when mounting bolts are excessively tightened. Plastics that are more rugged require lubrication due to the abrasive qualities of the strength enhancing additives.

Bearing assemblies, with either plastic or metal housings, may use spherical cartridge bearings. The spherical cartridge bearing has a spherically convex surface, usually made of metal, on the outer race that fits into the spherically concave surface of the bearing housing. The spherical surface of the bearing is typically produced with a grinding process. The tight fit of the surfaces holds the outer race to the housing such that there is no relative motion between the outer race and the bearing housing during use. In traditional metal pillow blocks, cartridge bearings are used and the spherical outer race is ground directly into the housing.

While plastic and metal housings are adequate solutions to preventing binding, an improved solution to preventing binding would combine the advantages of metal and plastic housings, while minimizing their respective disadvantages. The improved solution would further take advantage of readily available low cost bearing assemblies.

### SUMMARY OF TILE INVENTION

The present invention is a spherical compliant load ring that serves as the interface between the bearing and the bearing housing and allows the use of a standard cylindrical cartridge bearing. The spherical compliant load ring is an annular structure with a spherically convex surface that is used to mate with the spherically concave surface of the bearing housing. In its preferred embodiment, the ring is made of a material such as plastic, preferably Delrin®, that gives the ring its compliance, strength, and lubricity.

This invention combines the benefits of both metal housings and plastic housings while simplifying the overall complexity of manufacture of the components. Where it is advantageous to the application, one embodiment of this invention, the bearing assembly retains the metal housing without the need for grinding due to the compliance of the ring material. In addition, the compliant load ring captures the advantages of the plastic housing in that the concave spherical surface requires less precision and thus lower cost manufacturing. In addition, the invention surpasses previous designs in that it eliminates the need for the expensive spherical cartridge bearing and allows the use of the less expensive standard cylindrical cartridge bearing. The compliant ring minimizes the total volume of the plastic (i.e. compliant element) which will maximize the overall stiffiless of the system. This invention does not limit the choice of bearing housing material. The polymer compliant ring may have an added benefit of vibration damping.

### BRIEF DESCRIPTION OF DRAWINGS

Various other objects, advantages, and features of the invention will become apparent to those skilled in the art from the following discussion taken in conjunction with the following drawings, in which:

FIG. 1 is a perspective view of a bearing assembly using the intermediate compliant load ring.

FIG. 2 is an exploded perspective view of the bearing assembly shown in FIG. 1.

FIG. 3 is a perspective view of the intermediate compliant load ring.

FIG. 4 is a top view of the intermediate compliant load ring of FIG. 3.

FIG. 5 is a sectional view of the intermediate compliant load ring along line 4-4 of FIG. 4.

FIG. 6 is a perspective view of the complete bearing assembly.

FIG. 7 is a sectional view of the bearing assembly illustrated in FIG. 6 along line 6-6.

FIG. 8 is a perspective view of the bearing assembly using a pre-assembled bearing ring subassembly.

FIG. 9 is a perspective view of bearing with the a pre-assembled bearing ring subassembly inserted into the bearing housing.

FIG. 10 is a perspective view of a bearing assembly using the a pre-assembled bearing ring subassembly.

FIG. 11 is a perspective view of a first embodiment of a partial bearing assembly using a pre-assembled bearing ring subassembly.

FIG. 12 is a perspective view of a second embodiment of a partial bearing assembly using the overcast molded compliant load ring.

Similar reference characters denote corresponding features consistently throughout the attached drawings.

### DETAILED DESCRIPTION

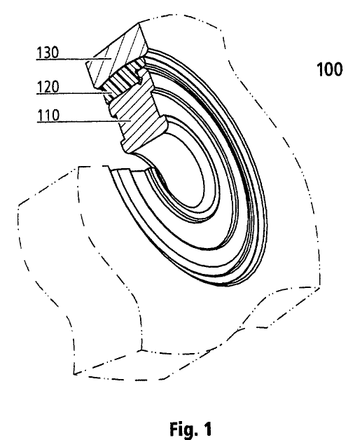

FIGS. 1 through 7 illustrate a bearing assembly with the spherical intermediate compliant load ring.

FIG. 1 is a partial perspective view of a bearing assembly 100 comprising a bearing 110 installed within the intermediate compliant spherical load ring 120, and the bearing 110 and the intermediate compliant spherical load ring 120 further installed in a bearing housing 130.

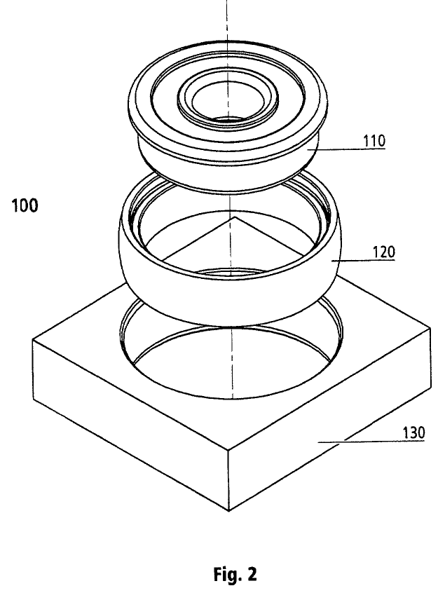

FIG. 2 is an exploded perspective view of the bearing assembly 100 shown in FIG. 1. FIG. 2 clearly shows the bearing 100, the intermediate compliant spherical load ring 120 having an annular structure and the bearing housing 130.

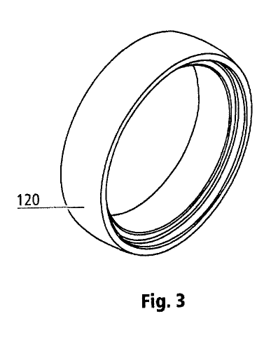

FIG. 3 illustrates a perspective view of the intermediate compliant spherical load ring 120.

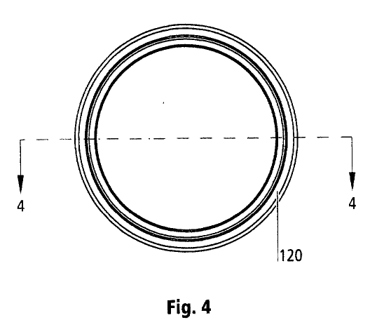

FIG. 4 further illustrates a top view of the intermediate compliant spherical load ring 120 of FIG. 3.

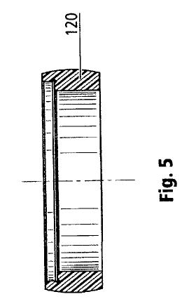

Illustrated in FIG. 5 is a sectional view of the intermediate compliant spherical load ring 120 along line 4-4 of FIG. 4.

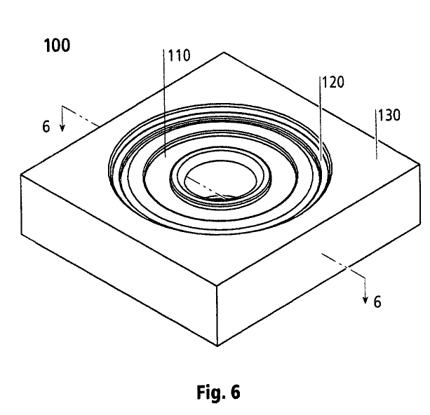

FIG. 6 demonstrates a perspective view of the complete bearing assembly 100.

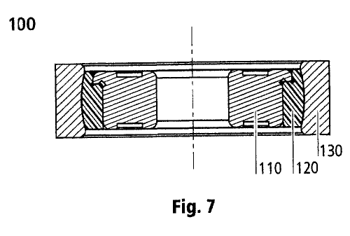

FIG. 7 is a sectional view of the bearing assembly 100 illustrated in FIG. 6 along line 6-6.

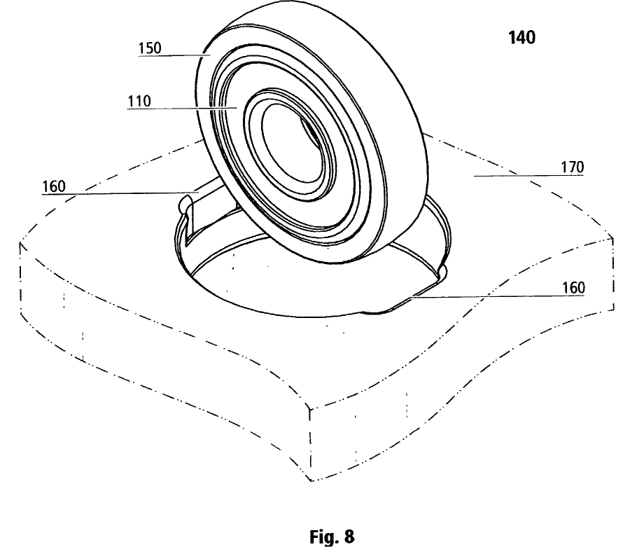

FIG. 8 demonstrates a second embodiment is a perspective view of a bearing assembly 140 using an overcast molded linear compliant spherical load ring 150. The overcast molded compliant spherical load ring 150 is molded directly to bearing 110. The bearing 110 and overcast molded linear compliant spherical load ring 150 are then installed into a bearing housing 170 which has two relief pockets 150 located on opposite sides. In an alternate embodiment, the bearing 110 and the intermediate compliant spherical load ring 120 are assembled before inserting into a bearing housing 170.

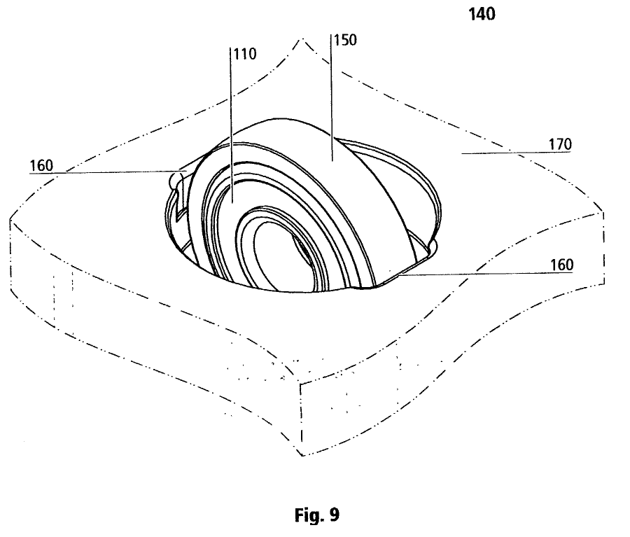

FIG. 9 illustrates a perspective view of bearing 110 with the overcast molded compliant spherical load ring 150 partially inserted into the bearing housing 170.

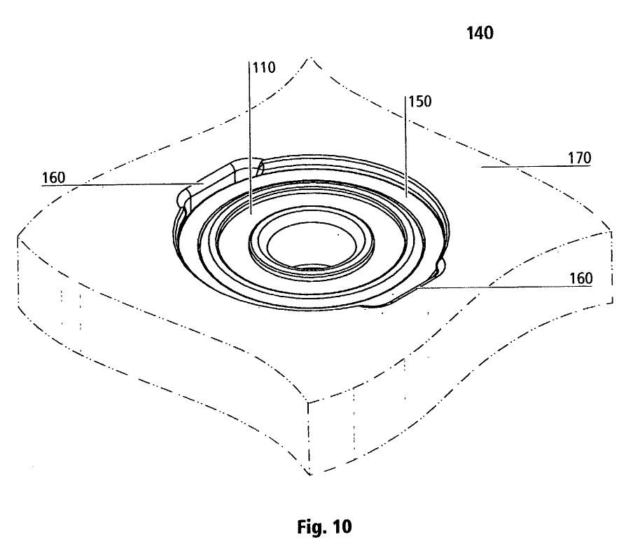

FIG. 10 demonstrates the complete bearing assembly 140 in which the bearing 110 with the overcast molded compliant spherical load ring 150 is seated in the bearing housing 170.

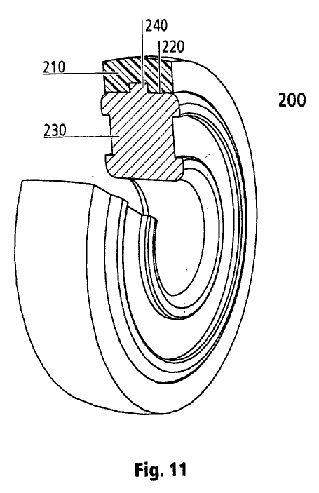

FIG. 11 is a perspective view of a first embodiment of a partial bearing assembly 200 using an overcast molded compliant load ring 210. The overcast molded compliant load ring 210 forms a mating surface 220 with the bearing 230 during the molding process. In this first embodiment, the bearing 230 has at least one ridge 240 to increase the mechanical bonding of the bearing assembly 200.

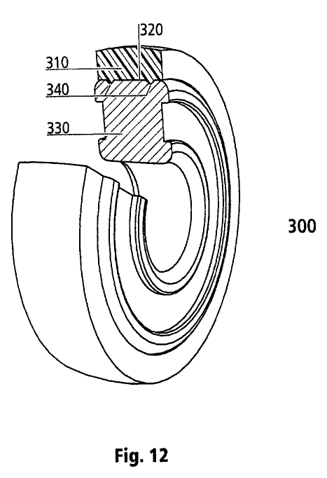

FIG. 12 is a perspective view of a second embodiment of a partial overcast molded bearing assembly 300. The overcast molded compliant load ring 310 forms a mating surface 320 with the bearing 310 during the molding process. In this second embodiment, the bearing 330 has at least one groove 340 cut or ground into the bearing's mating surface 320.

In the preferred embodiment of the present invention the bearing assembly, that takes a standard, commercially available bearing 110, and makes it self-aligning. In alternative embodiments, non-standard bearings may be used. The use of the plastic intermediate compliant spherical load ring 120 may have an added benefit of vibration damping.

Further in the preferred embodiment of the present invention, the intermediate compliant spherical load ring 120 is first inserted into the bearing housing 130. At insertion, the primary axis of the intermediate compliant spherical load ring 120 is perpendicular to the primary axis of the bearing housing 130. The compliance of the plastic allows the intermediate compliant spherical load ring 120 to “snap” into place. Once the intermediate compliant spherical load ring 120 is situated inside of the bearing housing 130, it is rotated such that its primary axis is aligned with the primary axis of the bearing housing 130. The bearing 110 is then inserted. The bearing 110 is a standard bearing including, but is not limited to a cartridge bearing, a roller bearing, a needle bearing, a ball bearing, a flange bearing, or a ring bearing. The bearing housing 130 is a material selected from the group consisting of, but not limited to metal, polymer, or ceramic. With the insertion of the bearing 110, deformation of the intermediate compliant spherical load ring 120 is constrained, and thus the intermediate compliant spherical load ring 120 is locked into the bearing housing 130. While securing the bearing 110 to the intermediate compliant spherical load ring 120 is preferred, it is not necessary for functionality. Gluing the bearing to the load ring is the preferred method of securing the bearing, however, other methods may be used.

The intermediate compliant spherical load ring 120 and the overcast molded compliant spherical load ring 150 in their preferred embodiments are made of a plastic polymer selected from the group consisting of, but not limited to urethane, Teflon®, Delrin®, Acetal, Polyphenylene Oxide (PPO), Ultem® (polyetherimide), Acrylonitrile-Butadiene-Styrene (ABS), or Nylon® (thermoplastic polyamides). The intermediate compliant spherical load ring 120 can be a separate piece from the bearing or fixed to the bearing through bonding means, selected from the group consisting of, but not limited to, glue, over molding, and other bonding means. The choice of material for the intermediate compliant spherical load ring 120 can eliminate the need for lubrication as in the case of Teflon® and Delrin®. The intermediate compliant spherical load ring 120 can be manufactured using methods selected from the group consisting of, but not limited to, injection molding, machining, or turning. The surface of the intermediate compliant spherical load ring 120 may be textured to increase compliance.

The intermediate compliant spherical load ring 120 is compatible for use with a bearing housing 130 of any configuration and of any material. In its preferred embodiment, the bearing housing 130 is made of a metal including, but not limited to aluminum and stainless steel. In alternative embodiments the bearing housing 130 may be made of other materials selected from the group consisting of, but not limited to, metal, polymer, or ceramic. The concave surface of the housing can be manufactured by conventional methods such as, but not limited to milling, or turning (preferably within a tool), without the tight tolerances, which typically require a grinding process.

In an alternative embodiment overcast molded compliant spherical load ring 150 is overcast molded onto the surface of the bearing 110. Typically two relief pockets 150 in the bearing housing 130 will be required for assembly. Such relief pockets 150 are well know to those in the art and are typically used on traditional bearing housings. The overcast molding process permanently affixes the plastic onto the surface of the bearing 110. In alternative embodiments as demonstrated in FIG. 11 and FIG. 12, features selected from the group consisting of, but not limited to, ribs, grooves, dimples, textures, or other shapes may be used to increase the dimensional compliance of the overcast molded compliant spherical load rings 210 in FIG. 11 and 310 in FIG. 12. Texturing may be applied to the spherical surface 260 in FIG. 11 and 360 in FIG. 12 or the bearing seat 250 in FIG. 11 and 350 in FIG. 12. The texturing on the bearing seat 250 in FIG. 11 and 350 in FIG. 12 may increase mechanical adhesion of adhesives. In still further alternate embodiments, treatments selected from the group consisting of, but not limited to, coatings, glues, bonding, or chemical may be used to promote adhesion. The intermediate compliant spherical load ring or the compliant spherical load ring is secured to the bearing by bonding means selected from the group consisting of, including but not limited to, gluing, friction, sonic welding or over-molding.

The preferred embodiments of the present invention disclosed herein have been discussed for the purpose of familiarizing the reader with the novel aspects of the invention. Although preferred embodiments of this invention have been shown, many changes, modifications, and substitutions may be made by one having ordinary skill in the art without departing from the scope and spirit of the invention as described in the following claims.

We claim:

1. A self-aligning bearing assembly, the bearing assembly comprising:
a bearing;
a bearing housing having a spherically concave inner surface; and
a spherical compliant load ring, wherein the spherical compliant load ring is an annular structure with a spherically convex surface that is used to mate with the spherically concave surface of the bearing housing and further the bearing is seated within the annular opening of the spherical compliant load ring, and still further the bearing assembly is manufactured by inserting the spherical compliant load ring into the bearing housing and then the bearing is inserted into the annular opening of the spherical compliant load ring.

2. The bearing assembly in claim 1, wherein the bearing is a standard bearing including, but not limited to a cartridge bearing, a roller bearing, a needle bearing, a ball bearing, a flange bearing, or a ring bearing.

3. The bearing assembly of claim 2, wherein the bearing housing is a material selected from the group consisting of, but not limited to, metal, polymer, or ceramic.

4. The bearing assembly of claim 3, wherein the intermediate compliant spherical load ring is a plastic polymer selected from the group consisting of, but not limited to urethane, Teflon®, Delrin®, Acetal, Polyphenylene Oxide (PPO), Ultem® (polyetherimide), Acrylonitrile-Butadiene-Styrene (ABS), or Nylon® (thermoplastic polyamides).

5. The bearing assembly of claim 4, wherein the intermediate compliant spherical load ring is manufactured by a method selected from the group consisting of, but not limited to, injection molding, machining, or turning.

6. The bearing assembly of claim 4, wherein the intermediate compliant spherical load ring has features selected from the group consisting of, but not limited to, ribs, grooves, dimples, textures, or other shapes to increase the dimensional compliance and promote adhesion between the overcast molded compliant spherical load ring and the bearing.

7. The bearing assembly of claim 4, wherein the intermediate compliant spherical load ring is secured to the bearing by bonding means selected from the group consisting of, including but not limited to, gluing or over-molding.

8. A self-aligning bearing assembly, the bearing assembly comprising:
a bearing;
a bearing housing having a spherically concave inner surface, the bearing housing further having at least one relief pocket; and
an overcast molded compliant spherical load ring, wherein the overcast molded compliant spherical load ring is an annular structure with a spherically convex surface that is overcast molded onto the outer surface of the bearing and further the bearing assembly is manufactured by insertion into the bearing housing using the at least one relief pocket to enable the insertion.

9. The bearing assembly in claim 8, wherein the bearing is a standard bearing selected from the group consisting of, but not limited to, a cartridge bearing, a roller bearing, a needle bearing, a ball bearing, a flange bearing, or a ring bearing.

10. The bearing assembly of claim 9, wherein the bearing housing is a material selected from the group consisting of, but not limited to, metal, polymer, or ceramic.

11. The bearing assembly of claim 10, wherein the overcast molded compliant spherical load ring is a plastic polymer selected from the group consisting of, but not limited to urethane, Teflon®, Delrin®, Acetal, Polyphenylene Oxide (PPO), Ultem® (polyetherimide), Acrylonitrile-Butadiene-Styrene (ABS), or Nylon® (thermoplastic polyamides).

12. The bearing assembly of claim 11, wherein the overcast molded compliant spherical load ring has features selected from the group consisting of, but not limited to, ribs, grooves, dimples, textures, or other shapes to increase the dimensional compliance and promote adhesion between the overcast molded compliant spherical load ring and the bearing.

13. A self-aligning bearing assembly, the bearing assembly comprising:
a bearing,
a bearing housing having a spherically concave inner surface, the bearing housing further having at least one relief pocket; and
a compliant spherical load ring, wherein the compliant spherical load ring is an annular structure with a spherically convex surface that is affixed by fastening means, including but not limited to gluing, friction or sonic welding, to the outer surface of the bearing and further the bearing assembly is manufactured by insertion into the bearing housing using the at least one relief pocket to enable the insertion.

14. The bearing assembly in claim 13, wherein the bearing is a standard bearing selected from the group consisting of, but not limited to, a cartridge bearing, a roller bearing, a needle bearing, a ball bearing, a flange bearing, or a ring bearing.

15. The bearing assembly of claim 14, wherein the bearing housing is a material selected from the group consisting of, but not limited to, metal, polymer, or ceramic.

16. The bearing assembly of claim 13, wherein the compliant spherical load ring is a plastic polymer selected from the group consisting of, but not limited urethane, Teflon®, Delrin®, Acetal, Polyphenylene Oxide (PPO), Ultem® (polyetherimide), Acrylonitrile-Butadiene-Styrene (ABS), or Nylon® (thermoplastic polyamides).

17. The bearing assembly of claim 16, wherein the compliant spherical load ring has features selected from the group consisting of, but not limited to, ribs, grooves, dimples, textures, or other shapes to increase the dimensional compliance and promote adhesion between the compliant spherical load ring and the bearing.
